(19) United States
(12) Patent Application Publication
(10) Pub. No.: US 2011/0281051 A1
(43) Pub. Date: Nov. 17, 2011

(54) USE OF AN EXPANDED GRAPHITE IN A POLYMER MATERIAL

(75) Inventors: Nicolas Dufaure, Bernay (FR); Benoit Brule, Beaumont-Le-Roger (FR); Samuel Devisme, Rouen (FR); Sylvain Benet, Bernay (FR)

(73) Assignee: ARKEMA FRANCE, Colombes (FR)

(21) Appl. No.: 13/131,657

(22) PCT Filed: Nov. 25, 2009
(86) PCT No.: PCT/FR2009/052288

§ 371 Date: Aug. 4, 2011

(30) Foreign Application Priority Data
Nov. 27, 2008 (FR) 0858056
Feb. 11, 2009 (FR) 0950851

(51) Int. Cl. H01B 1/24; B32B 1/00; B32B 1/08

(52) U.S. Cl. 428/36.9; 252/511; 428/35.7

(57) ABSTRACT

The present patent application relates to the use of expanded graphite, the specific surface of which is comprised between 15 and 30 m²/g and the bulk density of which is less than 0.1 g/cm³, for a mean particle size of greater than 15 μm, in order to confer, on a thermoplastic polymer, thermal conductivity, electrical conductivity and rheological properties suitable for the conversion of the said polymer.

### FIELD OF THE INVENTION

A subject-matter of the present invention is the use of a specific expanded graphite in polymer materials and in particular in thermoplastic polymers.

### PRIOR ART AND TECHNICAL PROBLEM

Generally, electrically conducting composite materials are composed of conducting particles dispersed in an organic or inorganic matrix. The conduction threshold or percolation threshold (insulator/conductor transition) is reached when the conducting particles form a network of conducting pathways connected throughout the volume of the composite material.

The conducting particles can be metallic, which exhibits the advantage of a good electrical conductivity. However, they exhibit the disadvantage of having a high density and of being sensitive to the chemical environment. Nonmetallic particles are particularly advantageous for their low density and their chemical resistance. The most widely used nonmetallic conducting fillers are carbon-based pulverulent products, such as carbon black or graphite powders, and carbon fibres.

It is also known that carbonaceous fillers, such as carbon fibres, carbon black or graphite, and also boron or aluminium nitrides have good thermal conductivity properties. For this reason, these fillers have been incorporated in polymer matrices in order to confer an improved thermal conductivity on the latter. It should be noted that polymers are very poor heat conductors, which limits the applications thereof if the specifications call for heat dissipation and/or exchange.

In recent years, the use of carbon nanotubes (also denoted CNTs) has very greatly expanded. This is because it has been found that these nanotubes confer, on the materials in which they have been incorporated, excellent thermal, electrical and, indeed even in some cases, mechanical properties (WO 91/03057, U.S. Pat. No. 5,744,235 and U.S. Pat. No. 5,445,327).

Carbon nanotubes have applications in numerous fields, in particular in electronics, in mechanical systems or in electromechanical systems. Specifically, in the field of electronics, according to their temperature and their structure, the composite materials in which the carbon nanotubes occur can be conducting, semiconducting or insulating. In mechanical systems, carbon nanotubes can be used for the reinforcing of composite materials. This is because carbon nanotubes are one hundred times stronger and six times lighter than steel. Finally, in the field of electromechanical systems, carbon nanotubes exhibit the advantage of being able to expand or contract by injecting charge. Mention may be made, for example, of the use of carbon nanotubes in macromolecular compositions intended for the packaging of electronic components, for the manufacture of fuel lines or antistatic coatings, in thermistors, electrodes for supercapacitors, and the like.

However, the carbonaceous fillers mentioned above and metal fillers have the disadvantage of having to be introduced at high contents (>20% by weight) in order to be able to significantly increase (by a factor of at least 2) the thermal conductivity of the material in which they occur. In point of fact, their presence in high contents very often affects the ability of the material to be formed.

Thus, there still exists a real need to find fillers exhibiting better thermal and electrical properties, which fillers are less dense or also less expensive. Furthermore, neither should these fillers compromise the conversion of the product according to conventional methods, such as extrusion or injection moulding.

### BRIEF DESCRIPTION OF THE INVENTION

The incorporation of expanded graphite in polymers makes it possible to obtain materials exhibiting thermal conductivities which are much greater than those known to date with carbon nanotubes, while exhibiting an electrical conductivity of the order of that obtained with carbon nanotubes and an improved fluidity, thus making possible easier forming of the material according to methods well known to a person skilled in the art (injection moulding, extrusion, and the like).

A subject-matter of the invention is the use of expanded graphite, the specific surface of which is comprised between 15 and 30 m²/g and the bulk density of which is less than 0.1 g/cm³, with a mean particle size of greater than 15 μm, in order to confer, on a polymer material and in particular on a thermoplastic polymer, thermal conductivity, electrical conductivity and rheological properties suitable for the conversion of the said polymer material.

Other subject-matters, aspects and characteristics of the invention will become apparent on reading the following description.

### DETAILED DESCRIPTION OF THE INVENTION

The term “expanded graphite” is understood to mean a graphite treated in order to increase the distance between the graphite sheets. This results in an increase in the specific surface and in a fall in the bulk density. The expanded graphite according to the invention is a graphite which exhibits a BET (Brunauer, Emmett and Teller) specific surface comprised between 15 and 30 m²/g and a bulk density (or Scott density) of less than 0.1 g/cm³, for a mean particle size of greater than 15 μm.

It is specified that the expression “comprised between” used in the preceding paragraphs but also in the continuation of the present description should be understood as including each of the limits mentioned.

The term “BET (Brunauer, Emmett and Teller) specific surface” is understood to mean the surface area available per gram of material. This measurement is based on an adsorption of gas at the surface of the solid studied, such as those described in Standards ASTM D6556 and ISO 9277:1995. Preferably, the BET specific surface is comprised between 20 and 30 m²/g.

The term “bulk density (or Scott density)” is understood to mean the density of the powder in its entirety, including the spaces comprised between the particles of micro- or nanometric size. This density can be measured according to standard methods, such as that described in detail in Standards ASTM B329 and ISO 3923-2:1981, using a Scott voltmeter. Preferably, the density is comprised between 0.01 and 0.09 g/cm³.

The term “mean particle size” is understood to mean a particle diameter such that 50% of the particles by weight have a diameter of less than this first diameter. This size can be measured by different methods; mention may be made of laser particle sizing or sieving. Preferably, the mean particle size is comprised between 20 and 500 μm.

The expanded graphite according to the invention can be obtained from Timcal, under the name BNB90.

The thermoplastic polymers according to the invention are chosen from homopolymers and copolymers of (meth)acrylic acid and of (meth)acrylic acid esters, vinyl polymers, aromatic and nonaromatic polyamides (PAs), polyether-block-amides (PEBAs), polycarbonates (PCs), functional or nonfunctional polyolefins, fluoropolymers, poly(arylene ether ketone)s (PAEKs) and copolymers predominantly comprising the monomers of the polymers mentioned above.

Mention may be made, among the above families of polymers, of:
homopolymers and copolymers of acrylic acid, homopolymers and copolymers of methacrylic acid, acrylic acid esters and methacrylic acid esters, such as alkyl methacrylates, for example poly(methyl methacrylate) (PMMA), ethyl methacrylate, n-butyl methacrylate and hexyl methacrylate; hydroxyalkyl (meth)acrylates, such as hydroxyethyl (meth)acrylate or hydroxypropyl (meth)acrylate; acrylamide and their blend;
vinyl polymers, such as polyvinyl alcohol, poly(vinyl chloride) (PVC), poly(vinylidene chloride) or poly(vinyl acetate), or copolymers of the abovementioned monomers with at least one copolymerizable monomer, such as an ethylene/vinyl acetate copolymer;
nonaromatic polyamides (PAs), such as homopolymers, such as the homopolyamide of lauryllactam (PA 12), the homopolyamide of 11-aminoundecanoic acid (PA 11), copolymers, or copolyamides, based on different amide units, such as, for example, the copolyamide obtained by polycondensation of lactam-6 and lactam-12 (PA 6/12), the homopolyamide obtained by polycondensation of decanediamine and decanedioic acid (PA 10.10) or the homopolyamide obtained by polycondensation of hexanediamine and dodecanedioic acid (PA 6.12); the nomenclature of the polyamides being known and described in Standard ISO 1874-1:1992, “Plastics—Polyamide (PA) moulding and extrusion materials Part 1: Designation”;
aromatic polyamides, in particular polyphthalamides (denoted PPAs). Preferably, the polyphthalamides are of formulae A/X.T and A/X.T/Y,

with A denoting an aliphatic compound of amino acid or lactam type; preferably, A denotes lauryllactam or 11-aminoundecanoic acid (A=11 or 12),

X denoting an aliphatic diamine comprising from 4 to 20 carbon atoms; preferably, X denotes decanediamine (X=10),

T denoting terephthalic acid,

Y denoting any aliphatic, cycloaliphatic or semiautomatic polyamide. Preferably, the polyphthalamide comprises from 0 to 2 mol of A units per 1 mol of X.T units and comprises from 0 to 50 mol % of Y with respect to the total number of moles of polyphthalamide.

This formula covers, for example, the copolyamide obtained by polycondensation of lauryllactam, decanediamine and terephthalic acid (PA 12/10.T), the copolyamide obtained by polycondensation of 11-aminoundecanoic acid, decanediamine and terephthalic acid (PA 11/10.T), the copolyamide obtained by polycondensation of 11-aminoundecanoic acid, hexanediamine and terephthalic acid (PA 11/6.T), the copolyamide obtained by polycondensation of hexanediamine, terephthalic acid and isophthalic acid (PA 6.I/6.T), the homopolyamide obtained by polycondensation of dodecanediamine and terephthalic acid (PA 12.T) and the terpolymer obtained by polycondensation of 11-aminoundecanoic acid, decanediamine, hexanediamine and terephthalic acid (PA 11/10.T/6.T).

Use may also be made, among the aromatic polyamides, of the homopolyamide obtained by polycondensation of meta-xylylenediamine, alone or as a mixture with para-xylylenediamine, and decanedioic acid (PA MXD.10).
polyamide blends, polyether-block-amides (PEBAs) and blends of polyamides and PEBA,
polycarbonates (PCs),
polyolefins, such as copolymers of ethylene or propylene, such as ethylene/propylene/diene copolymers, and of at least one acrylic or vinyl monomer, such as ethylene/alkyl (meth)acrylate copolymers, it being possible for these polyolefins to be functional, that is to say to additionally comprise a carboxylic acid, anhydride or epoxy functional group,
fluoropolymers, such as poly(vinylidene fluoride) (PVDF), the copolymer of ethylene and tetrafluoroethylene (ETFE) or the copolymer of ethylene, tetrafluoroethylene and hexafluoropropylene (EFEP);
poly(arylene ether ketone)s, also known as PAEKs,

and copolymers predominantly comprising the monomers of the polymers mentioned above.

Poly (arylene ether ketones) (PAEKs) comprise units of following formulae:

(—Ar—X—) and (—Ar₁—Y—)

in which:
Ar and Ar₁ each denote a divalent aromatic radical;
Ar and Ar₁ can preferably be chosen from 1,3-phenylene, 1,4-phenylene, 4,4′-biphenylene, 1,4-naphthylene, 1,5-naphthylene and 2,6-naphthylene;
X denotes an electron-withdrawing group; it can preferably be chosen from the carbonyl group and the sulphonyl group,
Y denotes a group chosen from an oxygen atom, a sulphur atom or an alkylene group, such as —CH₂— and isopropylidene.

In these units, at least 50%, preferably at least 70% and more particularly at least 80% of the X groups are a carbonyl group and at least 50%, preferably at least 70% and more particularly at least 80% of the Y groups represent an oxygen atom.

According to a preferred embodiment, 100% of the X groups denote a carbonyl group and 100% of the Y groups represent an oxygen atom.

More preferably, the poly(arylene ether ketone) (PAEK) can be chosen from:
a poly(ether ether ketone), also known as PEEK, comprising units of formula I:

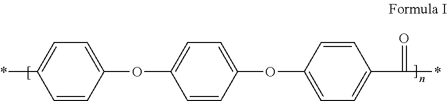

a poly(ether ketone), also known as PEK, comprising units of formula II:

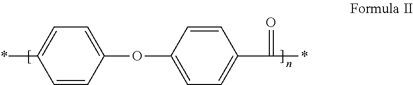

a poly(ether ketone ketone), also known as PEKK, comprising units of formula IIIA, of formula IIIB and their mixture:

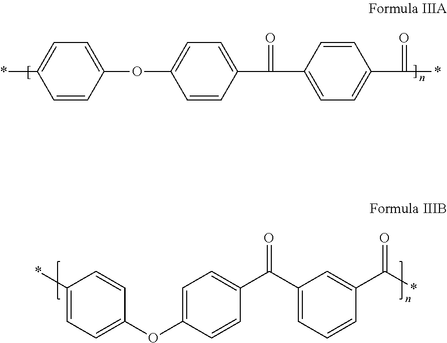

and a poly(ether ether ketone ketone), also known as PEEKK, comprising units of formula IV:

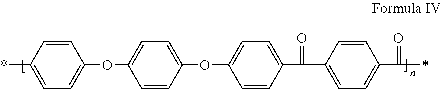

but other arrangements of the carbonyl group and of the oxygen atom are also possible.

The poly(arylene ether ketone) which can be used according to the invention can be crystalline, semicrystalline or amorphous.

Preferably, the thermoplastic polymers used are polyamides and more particularly PA 11, PA 12, PA 11/10.T, PA 11/6.T and PA MXD.10, as mentioned above.

Thus, the expanded graphite as defined above forms, with the thermoplastic polymer to which it is added, also defined above, a composition.

This composition comprises:
at least one thermoplastic polymer chosen from homopolymers and copolymers of (meth)acrylic acid and of (meth)acrylic acid esters, vinyl polymers, aromatic and nonaromatic polyamides (PAs), polyether-block-amides (PEBAs), polycarbonates (PCs), functional or nonfunctional polyolefins, fluoropolymers, poly(arylene ether ketone)s (PAEKs) and copolymers predominantly comprising the monomers of the polymers mentioned above,
at least 1% by weight, with respect to the total weight of the composition, of an expanded graphite, the BET specific surface of which is comprised between 15 and 30 m²/g and the bulk density of which is less than 0.1 g/cm³, for a mean particle size of greater than 15 μm.

The expanded graphite according to the invention is comprised, in the composition, between 1 and 50% by weight, with respect to the total weight of the composition, preferably between 5 and 35%.

The composition can also comprise, in addition, at least one additive.

This additive can be chosen in particular from impact modifiers, fibres, dyes, light stabilizers, in particular UV stabilizers, and/or heat stabilizers, plasticizers, mould-release agents, flame retardants, fillers other than the expanded graphite as described above, such as talc, glass fibres, pigments, metal oxides or metals, surface-active agents, optical brighteners, antioxidants, natural waxes and their mixtures.

Mention may in particular be made, among fillers other than the expanded graphite as described above, of silica, carbon black, carbon nanotubes, nonexpanded graphite, titanium oxide or glass beads.

Preferably, the additives are present in the composition generally in a content comprising between 0.1 and 50% by weight, preferably comprising between 0.5 and 40% by weight, with respect to the total weight of the composition.

The composition can occur in the form of a structure.

This structure can be a monolayer structure, when it is formed only of the composition.

This structure can also be a multilayer structure, when it comprises at least two layers and when at least one of the various layers forming the structure is formed from the composition.

The structure, whether monolayer or multilayer, can in particular be provided in the form of fibres (for example in order to form a woven or a nonwoven), of a film, of a sheet, of a pipe, of a hollow body or of an injection-moulded part.

Thus, any part intended to conduct heat can be produced from this composition. Consequently, some parts currently made of metal can be replaced by parts produced from the said composition. This replacement exhibits the advantage of resulting in a reduction in weight of the existing structures.

The composition as defined above can be prepared from the following preparation process. According to this process, the expanded graphite is introduced into the polymer matrix, the blending temperature being a function of the nature of the polymer or polymers used to form the matrix. This blending is carried out on a standard blending (compounding) device, such as a cokneader or a twin-screw extruder.

The composition as defined above can advantageously be used for the production of all or part of elements of motor vehicle equipment pieces, such as injection-moulded parts (whether or not the latter are positioned under an engine hood), in the aeronautical field for the replacement of metal parts, in the industrial field for the coating of reactor or heat exchanger, in the energy field, meeting the need to dissipate heat while rendering the parts lighter, in particular for cooling parts due to the increase in the powers, or for photovoltaic applications, for sports or leisure equipment, such as footwear requiring the dissipation of heat, or also for electrical and electronic components.

An article can be obtained by injection moulding, extrusion, coextrusion or hot compression moulding starting from at least one composition as defined above.

### EXAMPLES

### 1: Preparation of Compositions

a) Preparation in an Internal Mixer

The polymers and the fillers mentioned below are mixed in a Brabender internal mixer at a temperature of 260° C. for the polyamide or of 240° C. for the polyether-block-amides for 10 minutes at 50 rpm.

Polymers tested:
polyamide PA 12, sold by Arkema under the name Rilsan® AMNO TLD
polyether-block-amide, sold by Arkema under the name Pebax® 5533

Fillers tested:
expanded graphite according to the invention, sold by Timcal under the name BNB 90,
nanotubes (denoted CNTs), sold by Arkema in the form of MB Graphistrength®,
carbon black, sold by Timcal, under the name Ensaco 250G,
carbon fibres,
aluminium nitride, and
boron nitride.

The various combinations are tested:

A/ with a polyamide matrix of Rilsan® AMNO TLD type:
polyamide matrix alone, without filler,
polyamide matrix+5% of carbon nanotubes (CNTs)
polyamide matrix+10% of carbon nanotubes (CNTs)
polyamide matrix+15% of carbon nanotubes (CNTs)
polyamide matrix+20% of carbon nanotubes (CNTs)
polyamide matrix+20% of expanded graphite according to the invention
polyamide matrix+18% of expanded graphite according to the invention
polyamide matrix+20% of carbon black
polyamide matrix+20% of carbon fibres
polyamide matrix+10% of boron nitride
polyamide matrix+20% of boron nitride
polyamide matrix+20% of aluminium nitride
polyamide matrix+10% of carbon fibre+10% of carbon nanotubes (CNTs)
polyamide matrix+10% of expanded graphite according to the invention+10% of carbon nanotubes (CNTs)
polyamide matrix+10% of aluminium nitride+10% of carbon nanotubes (CNTs)
   B/ with a polyether-block-amide matrix of Pebax® 5533 type:
polyether-block-amide matrix alone, without filler,
polyether-block-amide matrix+10% of carbon nanotubes (CNTs)
polyether-block-amide matrix+15% of carbon nanotubes (CNTs)
polyether-block-amide matrix+20% of carbon nanotubes (CNTs)
polyether-block-amide matrix+20% of expanded graphite according to the invention
polyether-block-amide matrix+20% of carbon fibres
polyether-block-amide matrix+20% of aluminium nitride.

The compositions thus prepared are compressed in the form of plates with a thickness of 4 mm and with a side length of 6×6 cm². The plates are produced under the following conditions: preheating at 230° C. for 4 min without pressure, then 2 min at 230° C. under 100 bar and then 3 min under 50 bar while cooling.

b) Preparation in a Cokneader

7 compositions are prepared starting from the polymer and the fillers mentioned below. The compositions are produced using a Buss 15D cokneader rotating at 280 rpm and with the following temperature profile: 220° C. screw, barrel temperature: 240° C.

Polymer tested:
polyamide PA 11, sold by Arkema under the name Rilsan® BMNO

Fillers and additives tested:
expanded graphite according to the invention, sold by Timcal under the name BNB 90,
copolymer of ethylene and of propylene EPR (abbreviation for ethylene/propylene rubber) VA 1801, used as impact modifier;
polyether-block-amide, sold by Arkema under the name Pebax® MX1205, used as impact modifier,
nanotubes (denoted CNTs), sold by Arkema in the form of MB Graphistrength®,
nonexpanded graphite, sold by Timeal under the name KS 150.

Various combinations are tested with a polyamide matrix of Rilsan® BMNO TLD type:
polyamide matrix Rilsan® BMNO+20% of expanded graphite according to the invention
polyamide matrix+20% of expanded graphite according to the invention+10% of EPR VA 1801
polyamide matrix+20% of expanded graphite according to the invention+15% of Pebax® MX1205
polyamide matrix+10% of expanded graphite according to the invention
polyamide matrix+10% of expanded graphite according to the invention+3% of CNTs
polyamide matrix+15% of expanded graphite according to the invention
polyamide matrix+20% of nonexpanded graphite, sold by Timcal under the name KS 150.

The compositions are subsequently injection moulded in order to obtain plates with a thickness of 4 mm and with a side length of 10×10 cm². The feed/nozzle injection temperature is 260/280° C. and the mould is at 60° C.

2: Measurement of the Thermal Conductivity

The thermal conductivity of each of the plates produced is measured by the Hot Disk technique using the Hot Disk TPS 250 device developed by Thermoconcept.

The measurements made are given in the diagrams below:

2.1) with a polyamide matrix of Rilsan®AMNO TLD type:

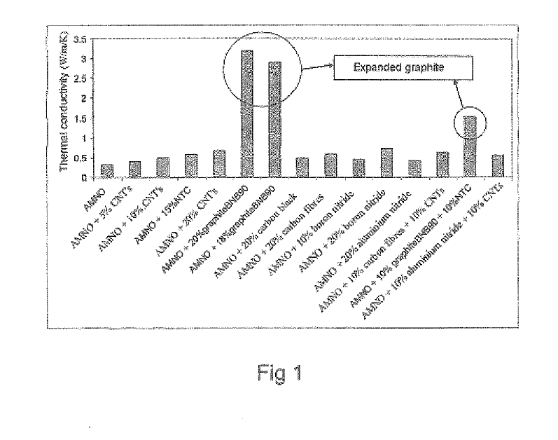

See FIG. 1

2.2) with a polyether-block-amide matrix of Pebax®5533 type:

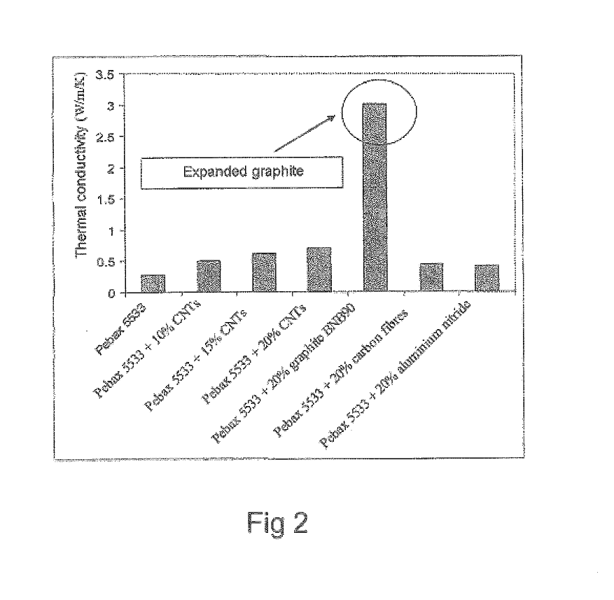

See FIG. 2

2.3) with a polyamide matrix of Rilsan® BMNO TLD type:

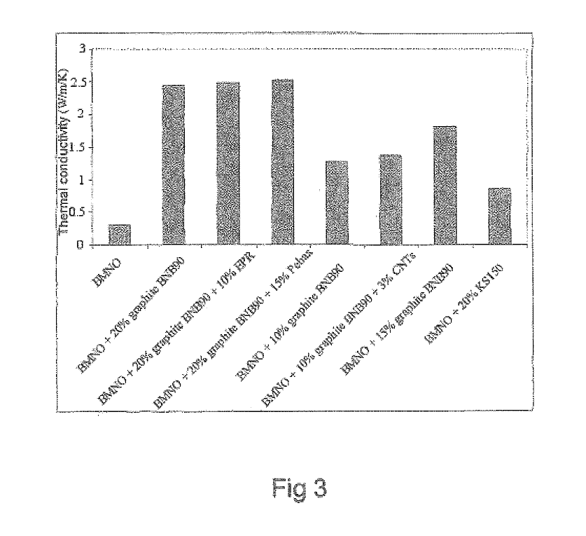

See FIG. 3

These results show that the presence of expanded graphite within the polymer matrix makes it possible to obtain a thermal conductivity which is greater than the thermal conductivities obtained with conventional fillers, whether with carbon nanotubes or nonexpanded graphite.

The expanded graphite according to the invention has a much greater effect than the other carbonaceous fillers on the thermal conductivity: for example, it has been calculated that, introduced at 2% into a polymer matrix, it brings about a thermal conductivity equivalent to that obtained with a mixture of the same matrix with 10% of carbon nanotubes.

3: Measurement of the Electrical Conductivity

The electrical conductivity of plates produced is measured by the electrodes method. The electrodes are produced with silver lacquer. The surface resistance between the two electrodes is measured using a megohmmeter.

The measurements made are given in the table below:

| | Surface |
|---|---|
| Materials | resistance (ohm) |
| AMNO alone (comparative) | 1 × 10¹⁴ |
| AMNO + 20% CNTs (comparative) | 2 × 10³ |
| AMNO + 20% carbon black | 9 × 10³ |
| (comparative) | |
| AMNO + 10% BNB 90 + 10% CNTs | 2 × 10³ |
| (according to the invention) | |
| AMNO + 20% BNB 90 | 2 × 10³ |
| (according to the invention) | |

These results show that the presence of expanded graphite within the polymer matrix makes it possible to obtain an electrical conductivity comparable to that obtained with the carbon nanotubes, i.e. a highly satisfactory electrical conductivity.

4: Measurement of the Flow Properties of the Molten Materials

The viscoelastic behaviour of some blends prepared according to Example 1.a was studied using a Physica MCR301 controlled-stress rheometer. The temperature was set at 260° C. The complex viscosity moduli at 1.35 rad/s are given in the table below:

| | Complex |
|---|---|
| Materials | viscosity (Pa · s) |
| AMNO alone (comparative) | 61 |
| AMNO + 5% CNTs (comparative) | 4750 |
| AMNO + 10% CNTs (comparative) | 37 000 |
| AMNO + 20% CNTs (comparative) | 556 000 |
| AMNO + 10% CNTs + 10% BNB90 | 131 000 |
| (according to the invention) | |
| AMNO + 20% BNB90 (according | 5790 |
| to the invention) | |

The more fluid the material (low viscosity), the easier it will be to process during its conversion.

These results show that the low-frequency viscosity is increased to a much lesser extent when the material comprises expanded graphite according to the invention, in comparison with the material comprising CNTs. The material comprising 20% of expanded graphite exhibits a viscosity comparable to that measured for a material comprising 5% of CNTs.

### CONCLUSION

The material comprising expanded graphite has a much greater effect than the other carbonaceous fillers on the thermal conductivity, has an effect comparable to the carbon nanotubes on the electrical conductivity and is much more fluid.

1.-9. (canceled)

10. A composition comprising expanded graphite,
the BET specific surface of which, measured according to Standard ASTM D6556 or ISO 9277, is comprised between 15 and 30 m²/g,
the bulk density of which, measured according to Standard ASTM B329 or ISO 3923-2, is less than 0.1 g/cm³,
for a mean particle size, measured by laser particle sizing or sieving, of greater than 15 μm, and
a thermoplastic polymer, said composition having superior thermal conductivity properties, comparable electrical conductivity properties and an improved fluidity, with respect to those obtained with the use of carbon nanotubes.

11. The composition according to claim 10, comprising at least one thermoplastic polymer that is a homopolymer or copolymer of (meth)acrylic acid or of (meth)acrylic acid esters, a vinyl polymer, an aromatic or nonaromatic polyamide (PA), a polyether-block-amide (PEBA), a polycarbonate (PC), a functional or nonfunctional polyolefin, a fluoropolymer, a poly(arylene ether ketone) (PAEK) or a copolymer predominantly comprising monomers of the polymers mentioned above.

12. The composition according to claim 10, wherein the expanded graphite is present in a content comprised between 1 and 50% by weight, with respect to the total weight of the composition.

13. The composition according to claim 10, wherein the thermoplastic polymer is an aromatic or nonaromatic polyamide, polyether-block-amide or a poly(arylene ether ketone).

14. The composition according to claim 13, wherein the thermoplastic polymer is a homopolyamide of lauryllactam (PA 12), a homopolyamide of 11-aminoundecanoic acid (PA 11), a copolyamide obtained by polycondensation of lauryllactam, decanediamine and terephthalic acid (PA 12/10.T), a copolyamide obtained by polycondensation of 11-aminoundecanoic acid, decanediamine and terephthalic acid (PA 11/10.T), a copolyamide obtained by polycondensation of 11-aminoundecanoic acid, hexanediamine and terephthalic acid (PA 11/6.T), a copolyamide obtained by polycondensation of hexanediamine, terephthalic acid and isophthalic acid (PA 6.I/6.T), a homopolyamide obtained by polycondensation of dodecanediamine and terephthalic acid (PA 12.T), a terpolymer obtained by polycondensation of 11-aminoundecanoic acid, decanediamine, hexanediamine and terephthalic acid (PA 11/10.T/6.T) or a homopolyamide obtained by polycondensation of meta-xylylenediamine, alone or as a mixture with para-xylylenediamine, and decanedioic acid (PA MXD.10).

15. The composition according to claim 13, wherein the poly(arylene ether ketone) is:
a poly(ether ether ketone) comprising units of formula I: 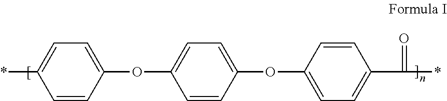
a poly(ether ketone) comprising units of formula II: 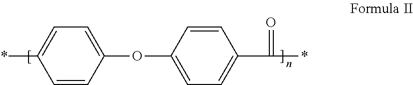
a poly(ether ketone ketone) comprising units of formula IIIA, of formula IIIB or their mixture: 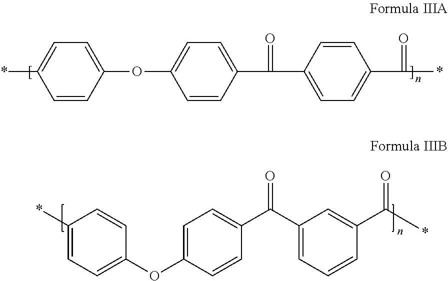
or a poly(ether ether ketone ketone) comprising units of formula IV:

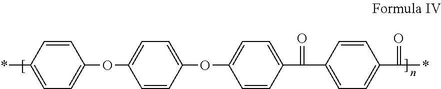

16. The composition according to claim 10, wherein comprising at least one additive that is impact modifiers, fibres, dyes, light stabilizers, heat stabilizers, plasticizers, mould-release agents, flame retardants, surface-active agents, brighteners, antioxidants, lubricants, UV stabilizers, antistatic agents, natural waxes, or fillers other than the expanded graphite as defined in claim 1.

17. The composition according to claim 10, wherein composition can be converted by injection moulding, by extrusion, by coextrusion or by hot compression moulding.

18. The composition according to claim 10, provided in the form of a monolayer structure or of a multilayer structure comprising at least two layers, at least one of the various layers of which is formed of the said composition.

19. The composition according to claim 18, wherein the structure is provided in the form of fibres, of a film, of a sheet, of a pipe, of a hollow body or of an injection-moulded part.

20. In electrical or electronic components, reactor or heat exchanger coatings, sports equipment, motor vehicle parts or parts for the aeronautical industry comprising a conductive polymer composition, the improvement wherein the composition is one according to claim 10.

21. The composition according to claim 16, comprising filters that are glass fibers, pigments, metal oxides, metals or mixtures thereof.

22. A composition comprising 5 to 35% by weight, based on total weight of the composition, of expanded graphite,
the BET specific surface of which, measured according to Standard ASTM D6556 or ISO 9277, is comprised between 15 and 30 m²/g,
the bulk density of which, measured according to Standard ASTM B329 or ISO 3923-2, is less than 0.1 g/cm³,
for a mean particle size, measured by laser particle sizing or sieving, of greater than 15 μm, and
a thermoplastic polymer, said composition having superior thermal conductivity properties, comparable electrical conductivity properties and an improved fluidity, with respect to those obtained with the use of carbon nanotubes.
